(19) United States
(12) Patent Application Publication
(10) Pub. No.: US 2020/0142523 A1
(43) Pub. Date: May 7, 2020

(54) TOUCH CONTROL PANEL AND DISPLAY AND TOUCH CONTROL DEVICE

(71) Applicant: Wuhan China Star Optoelectronics Technology Co., Ltd., Wuhan, Hubei (CN)

(72) Inventors: Yaoli HUANG, Wuhan, Hubei (CN); Xinglong HE, Wuhan, Hubei (CN)

(73) Assignee: Wuhan China Star Optoeletronics Technology Co., Ltd., Wuhan, Hubei (CN)

(21) Appl. No.: 16/326,199

(22) PCT Filed: Sep. 13, 2018
(86) PCT No.: PCT/CN2018/105461

§ 371 Date: Feb. 17, 2019

(30) Foreign Application Priority Data
Aug. 29, 2018 (CN) 201810997069.4

(51) Int. Cl. G06F 3/047; G06F 3/041

(52) U.S. Cl. CPC G06F 3/047; G06F 2203/04107; G06F 3/0416

(57) ABSTRACT

A touch control panel and a display and touch control device is provided. The touch control panel includes a display and touch chip, touch wires and a grounding wire. The touch wires are connected to a display and touch region and a first touch pin. The grounding wire is connected to a ground phase of the display and touch region and a second touch pin. In the present application, since the second touch pin is connected to the ground phase of the touch control panel by the grounding wire, the mutual interference between signals in the display and touch chip and the damage to circuits in the display and touch chip from static electricity are avoided.

### FIELD OF THE INVENTION

The present application relates to the technical field of touch and display, and in particular to a touch control panel and a display and touch control device.

### DESCRIPTION OF THE RELATED ART

As an input medium, the touch screen realizes the most simple, convenient and natural human-machine interaction at present. Due to its good electrical controllability, liquid crystal is increasingly used in display panels. Therefore, touch screens are usually integrated into liquid crystal display panels to form various electronic products, for example, mobile phones, notebook computers, MP3/MP4 or the like.

In order to reduce the thickness of devices such as mobile phones and improve the user experience, display devices have been widely integrated with touch screens. A display IC is also integrated with a touch IC to form a touch and display chip (also referred to as TDDI). Since the TDDI integrates the display IC and the touch IC into one IC, display and touch signals are easily interfered with each other in the same IC. Therefore, the mutual interference of TDDI signals has always been a problem in this industry.

Referring to FIG. 1, a touch control panel is divided into a display and touch region D1′ and a non-display touch region D2′. A display and touch chip TDDI (1′) is disposed in the non-display touch region D2′. The TDDI comprises a first touch pin 11′ for connecting the display and touch region D1′ and a spare second touch pin 12′. The first touch pin 11′ is connected to the display and touch region D1 by touch wires 13′.

Generally, there may be 500 to 600 touch signal pins reserved in the TDDI. Actually, it may be impossible to use all the touch signal pins, and some touch signal pins 12′ will be left spare and suspended. External static electricity and display interference signals are likely to get into the suspended pins 12′, resulting in low touch sensitivity or even influencing the normal touch experience.

Therefore, it is necessary to provide a touch control panel which can prevent touch pins from receiving external static electricity and display interference signals, in order to solve the above technical problem.

### Technical Problem

Embodiments of the present invention provide a touch control panel and a display and touch control device, in order to solve the technical problem of undesirable touch sensitivity of existing touch control panels and display and touch control devices due to the reception of external static electricity and display interference signals by spare touch pins.

### Summary of the Technical Solution

The embodiments of the present application provide a touch control panel which is divided into a display and touch region and a non-display touch region disposed on one side of the display and touch region, wherein the touch control panel includes:

a display and touch chip, which is disposed in the non-display touch region and configured to realize display and touch functions of the panel, and which includes a first touch pin for connecting the display and touch region to realize the touch function and a spare second touch pin;

touch wires, which are disposed between the display and touch chip and the display and touch region and connected to the display and touch region and the first touch pin; and

a grounding wire, which is disposed in the non-display touch region and connected to a ground phase of the display and touch region and the second touch pin;

the grounding wire includes a grounding wire branch connected to the second touch pin and a main grounding wire connected to the ground phase of the display and touch region;

wherein the main grounding wire includes a first wire section disposed below the display and touch chip and second wire sections which are connected to the first wire section and located on outer sides of the touch wires, the second wire sections are connected to the ground phase of the display and touch region, the width of the grounding wire branch is less than the width of the main grounding wire, and the grounding wire branch is connected to the second touch pin by a conducting adhesive.

In the touch control panel of the present disclosure, there are two second wire sections which are disposed on two sides of all the touch wires to be connected to the first wire section to form a structure surrounding all the touch wires.

In the touch control panel of the present disclosure, there are at least two groups of touch wires; the main grounding wire further comprises a third wire section disposed between two adjacent groups of touch wires; and, the third wire section is extended along an edge between the two groups of touch wires to form a sinuous wire section connected to the first wire section.

In the touch control panel of the present disclosure, the grounding wire branch is connected to the first wire section.

The embodiments of the present application provide another touch control panel which is divided into a display and touch region and a non-display touch region disposed on one side of the display and touch region, wherein the touch control panel includes:

a display and touch chip, which is disposed in the non-display touch region and configured to realize display and touch functions of the panel, and which comprises a first touch pin for connecting the display and touch region to realize the touch function and a spare second touch pin;

touch wires, which are disposed between the display and touch chip and the display and touch region and connected to the display and touch region and the first touch pin; and

a grounding wire, which is disposed in the non-display touch region and connected to a ground phase of the display and touch region and the second touch pin.

In the touch control panel of the present disclosure, the grounding wire comprises a grounding wire branch connected to the second touch pin and a main grounding wire connected to the ground phase of the display and touch region; wherein the main grounding wire comprises a first wire section disposed below the display and touch chip and second wire sections which are connected to the first wire section and located on outer sides of the touch wires, the second wire sections are connected to the ground phase of the display and touch region.

In the touch control panel of the present disclosure, there are two second wire sections which are disposed on two sides of all the touch wires to be connected to the first wire section to form a structure surrounding all the touch wires.

In the touch control panel of the present disclosure, there are at least two groups of touch wires; the main grounding wire further comprises a third wire section disposed between two adjacent groups of touch wires; and, the third wire section is extended along an edge between the two groups of touch wires to form a sinuous wire section connected to the first wire section.

In the touch control panel of the present disclosure, the grounding wire branch is connected to the first wire section.

In the touch control panel of the present disclosure, the width of the grounding wire branch is less than the width of the main grounding wire.

In the touch control panel of the present disclosure, the grounding wire branch is connected to the second touch pin by a conducting adhesive.

The present disclosure further relates to a display and touch control device, including a touch control panel and an iron back plate disposed in a back of the touch control panel, wherein the touch control panel includes:

a display and touch chip, which is disposed in the non-display touch region and configured to realize display and touch functions of the panel, and which comprises a first touch pin for connecting the display and touch region to realize the touch function and a spare second touch pin;

touch wires, which are disposed between the display and touch chip and the display and touch region and connected to the display and touch region and the first touch pin; and

a grounding wire disposed in the non-display touch region, the grounding wire being connected to a ground phase of the display and touch region or the grounded iron back plate.

In the display and touch control device of the present disclosure, when the grounding wire is connected to the ground phase of the display and touch region, the grounding wire comprises a grounding wire branch connected to the second touch pin and a main grounding wire connected to the ground phase of the display and touch region;

the main grounding wire comprises a first wire section disposed below the display and touch chip and second wire sections which are connected to the first wire section and located outside the touch wires; and

there are two second wire sections which are disposed on two sides of all the touch wires so that the main grounding wire surrounds all the touch wires, and the second wire sections are connected to the ground phase of the display and touch region.

In the display and touch control device of the present disclosure, there are at least two groups of touch wires; the main grounding wire further comprises a third wire section disposed between two adjacent groups of touch wires; and, the third wire section is extended along an edge between the two groups of touch wires to form a sinuous wire section connected to the first wire section.

In the display and touch control device of the present disclosure, the grounding wire branch is connected to the first wire section.

In the display and touch control device of the present disclosure, the width of the grounding wire branch is less than the width of the main grounding wire.

In the display and touch control device of the present disclosure, the grounding wire branch is connected to the second touch pin by a conducting adhesive.

In the display and touch control device of the present disclosure, when the grounding wire is connected to the iron back plate, the grounding wire is connected to the iron back plate by an FPC (flexible printed circuit) board.

### Technical Effects

Compared with the touch control panels and the display and touch control devices in the prior art, in the touch control panel and the display and touch control device of the present application, the spare second touch pin is connected to the ground phase of the touch control panel or the grounded iron back plate by the grounding wire. When an interference signal or the static electricity gets into the second touch pin, the interference signal and the static electricity will be led away by the grounding wire. Thus, the mutual interference between signals in the display and touch chip and the damage to circuits in the display and touch chip from the static electricity are avoided. Therefore, the technical problem of undesirable touch sensitivity of existing touch control panels and display and touch control devices due to the reception of external static electricity and display interference signals by spare touch pins is solved.

### BRIEF DESCRIPTION OF THE DRAWINGS

In order to explain the technical solutions in the present embodiments or in the prior art more clearly, accompanying drawings required in the description of the present embodiments or prior art will be briefly described. Obviously, accompanying drawings are just some embodiments of the present disclosure, while other drawings may be obtained by those skilled in the art according to these drawings, without paying out any creative work.

FIG. 1 is a schematic structure diagram of a touch control panel in the prior art.

FIG. 2 is a schematic structure diagram of a first embodiment of a touch control panel according to the present application.

FIG. 3 is a schematic structure diagram of a second embodiment of the touch control panel according to the present application.

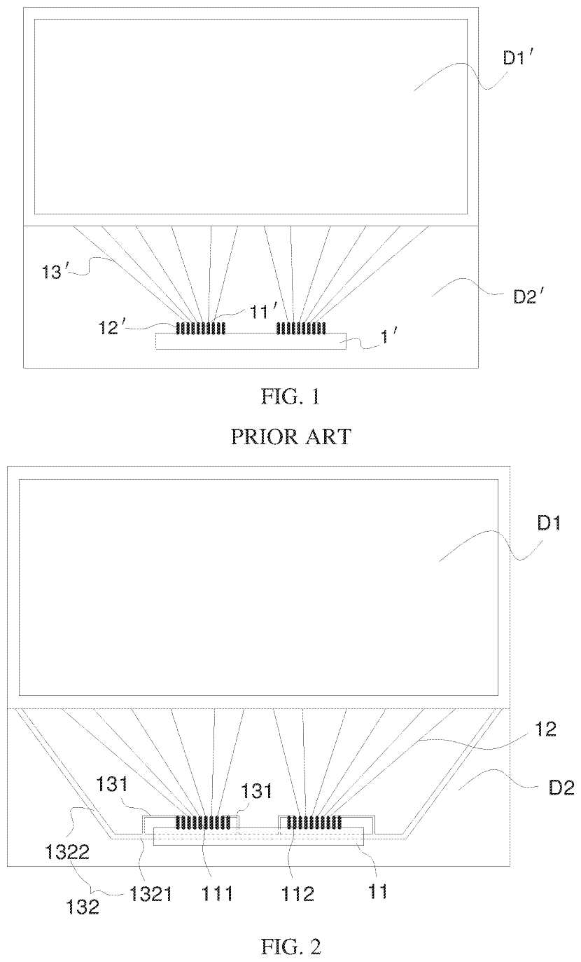

### DETAILED DESCRIPTION OF THE PREFERRED EMBODIMENTS

Throughout the accompanying drawings, the similar reference symbols represent similar components. The following description is based on the illustrated specific embodiments of the present application and shall not be regarded as limiting other specific embodiments of the present application not listed here.

Referring to FIG. 2, FIG. 2 is a schematic structure diagram of a first embodiment of a touch control panel according to the present application.

In the first embodiment, the touch control panel is divided into a display and touch region D1 and a non-display touch region D2 disposed on one side of the display and touch region D1, and the touch control panel includes a display and touch chip 11, touch wires 12 and a grounding wire.

The display and touch chip 11 is disposed in the non-display touch region D2 and configured to realize display and touch functions of the panel, and includes a first touch pin 111 for connecting the display and touch region D1 to realize the touch function and a spare second touch pin 112. The touch wires 12 are disposed between the display and touch chip 11 and the display and touch region D1 and connected to the display and touch region D1 and the first touch pin 111.

The grounding wire is disposed in the non-display touch region D2 and connected to a ground phase of the display and touch region D1 and the second touch pin 112.

In the first embodiment, the spare second touch pin 112 is connected to the ground phase of the touch control panel by the grounding wire. When an interference signal or the static electricity gets into the second touch pin 112, the interference signal and the static electricity will be led away by the grounding wire. Thus, the mutual interference between signals in the display and touch chip 11 and the damage to circuits in the display and touch chip 11 from the static electricity are avoided.

In the first embodiment, the grounding wire includes a grounding wire branch 131 connected to the second touch pin 112 and a main grounding wire 132 connected to the ground phase of the display and touch region D1. The grounding wire branch 131 is connected to the main grounding wire.

The main grounding wire 132 includes a first wire section 1321 disposed below the display and touch chip 11 and second wire sections 1322 which are connected to the first wire section 1321 and located on outer sides of the touch wires 12. The second wire sections 1322 are connected to the ground phase of the display and touch region D1.

The grounding wire is connected in advance to the ground phase of the display and touch region D1 and to a binding component for binding the display and touch chip 11 in the non-display touch region D2, and is buried below the display and touch chip 11. When the display and touch chip 11 is bound in the non-display touch region D2, the second touch pin 112 of the display and touch chip 11 is electrically connected to the binding component by a conducting adhesive.

In addition, there are two second wire sections 1322 which are disposed on two sides of all the touch wires 12 to be connected to the first wire section 1321 to form a structure surrounding all the touch wires 12. The whole main grounding wire 132 surrounds all the touch wires 12. When the static electricity gets into the touch pins from outside, the static electricity will come into contact with the main grounding wire 132 and this may prevent the static electricity from getting into the touch wires 12. Thus, the risk of the static electricity getting into the touch wires 12 may be reduced.

Moreover, the second wire sections 1322 on two sides are connected to the ground phase of the display and touch region D1 in order to improve the efficiency of leading away the static electricity and the interference signals.

In this embodiment, since the first wire section 1321 is closest to the second touch pin 112, the grounding wire branch 131 is connected to the first wire section 1321 in order to reduce the connection distance.

The width of the grounding wire branch 131 is less than the width of the main grounding wire.

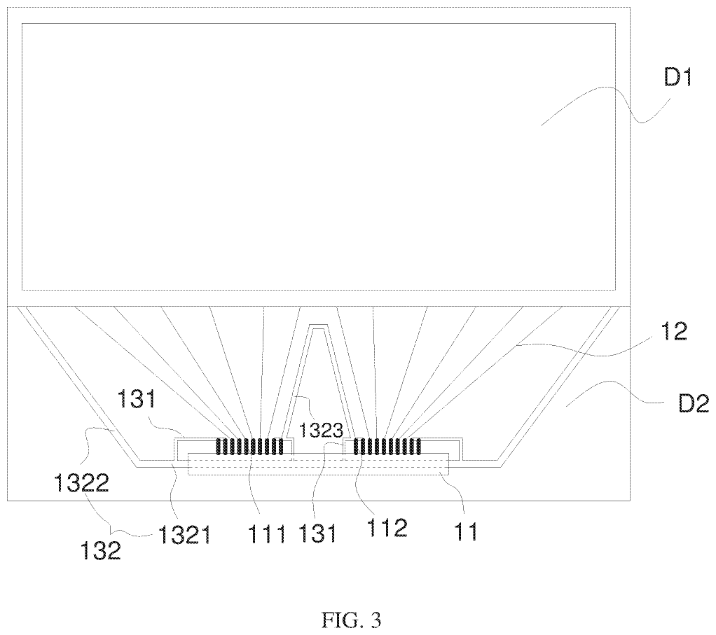

The difference between the second embodiment as shown in FIG. 3 and the first embodiment lies in that: on the basis of the first embodiment, there are at least two groups of touch wires 12; the main grounding wire further includes a third wire section 1323 disposed between two adjacent groups of touch wires 12; and the third wire section 1323 is extended along an edge between the two groups of touch wires 12 to form a sinuous wire section connected to the first wire section 1321.

In the second embodiment, there are, but not limited to, two groups of touch wires 12. The number of touch wires 12 may be set according to the actual situation.

When the display and touch chip 11 has two groups of touch pins, the second touch pins 112 in the groups of touch pins are arranged on two sides or in a surrounding region, and the first touch pins 111 are arranged in a middle region. By such an arrangement, it is convenient to arrange the touch wires 12 and the grounding wire, and also convenient for the grounding wire to surround the touch wires 12.

The third wire section 1323 may be directly connected to the first wire section 1321, or may be connected to two grounding wire branches 131 between the two groups of touch pins. In the second embodiment, by connecting the third wire section 1323 to two grounding wire branches 131 between the two groups of touch pins, the material is saved and the cost is reduced; and on the other hand, by connecting the third wire section 1323 to the grounding wire branches 131 between the touch pins on two sides, the interference is further reduced.

By providing the sinuous third wire section 1321 between the two groups of touch wires 12, the whole grounding wire 132 completely surround all the touch wires 12 from inside out. When the static electricity gets into the touch pins from inside, the static electricity firstly gets into the third wire section 1323. Thus, the risk of the static electricity getting into the touch wires 12 is reduced, and the display and touch chip 11 is protected.

The present application further relates to a display and touch control device, including a touch control panel and an iron back plate disposed in a back of the touch control panel, the touch control panel being divided into a display and touch region and a non-display touch region disposed on one side of the display and touch region, wherein the touch control panel includes:

a display and touch chip, which is disposed in the non-display touch region and configured to realize display and touch functions of the panel, and which includes a first touch pin for connecting the display and touch region to realize the touch function and a spare second touch pin;

touch wires, which are disposed between the display and touch chip and the display and touch region and connected to the display and touch region and the first touch pin; and

a grounding wire disposed in the non-display touch region, the grounding wire being connected to a ground phase of the display and touch region or the grounded iron back plate.

In the display and touch control device of the present application, when the grounding wire is connected to the ground phase of the display and touch region, the grounding wire includes a grounding wire branch connected to the second touch pin and a main grounding wire connected to the ground phase of the display and touch region;

the main grounding wire includes a first wire section disposed below the display and touch chip and second wire sections which are connected to the first wire section and located outside the touch wires; and

there are two second wire sections which are disposed on two sides of all the touch wires so that the main grounding wire surrounds all the touch wires, and the second wire sections are connected to the ground phase of the display and touch region.

In the display and touch control device of the present application, there are at least two groups of touch wires; the main grounding wire further includes a third wire section disposed between two adjacent groups of touch wires; and, the third wire section is extended along an edge between the two groups of touch wires to form a sinuous wire section connected to the first wire section.

In the display and touch control device of the present application, the grounding wire branch is connected to the first wire section.

In the display and touch control device of the present application, the width of the grounding wire branch is less than the width of the main grounding wire.

In the display and touch control device of the present application, the grounding wire branch is connected to the second touch pin by a conducting adhesive.

In the display and touch control device of the present application, when the grounding wire is connected to the iron back plate, the grounding wire is connected to the iron back plate by an FPC (flexible printed circuit) board.

Compared with the touch control panels and the display and touch control devices in the prior art, in the touch control panel and the display and touch control device of the present application, the spare second touch pin is connected to the ground phase of the touch control panel or the grounded iron back plate by the grounding wire. When an interference signal or the static electricity gets into the second touch pin, the interference signal and the static electricity will be led away by the grounding wire. Thus, the mutual interference between signals in the display and touch chip and the damage to circuits in the display and touch chip from the static electricity are avoided. Therefore, the technical problem of undesirable touch sensitivity of existing touch control panels and display and touch control devices due to the reception of external static electricity and display interference signals by spare touch pins is solved.

Although the present disclosure has been illustrated and described by one or more implementations, those skilled in the art will conceive of equivalent variants and modifications based on the reading and understanding of this description and the accompanying drawings. The present disclosure incorporates all such modifications and variants, and is only subject to the scope of the appended claims. In addition, although particular features of the present disclosure have been disclosed in only one of various implementations, those features may be combined with one or more other features of other implementations which are desirable and advantageous for a given or particular application. Moreover, when the term “comprise”, “have”, “contain” or variants thereof is used in specific implementations or claims, the term is intended to be inclusive in a manner similar to the term “include”.

In conclusion, although the present application has been disclosed above by embodiments, the serial numbers such as “first” and “second” before the embodiments are merely used for ease of description and not intended to limit the order of the embodiments of the present application. In addition, the above embodiments are not intended to limit the present application, and those skilled in the art can make various alterations and embellishments without departing from the spirit and scope of the present application. Therefore, the protection scope of the present application is subject to the scope defined by the appended claims.

What is claimed is:

1. A touch control panel which is divided into a display and touch region and a non-display touch region disposed on one side of the display and touch region, wherein the touch control panel comprises:
a display and touch chip, which is disposed in the non-display touch region and configured to realize display and touch functions of the panel, and which comprises a first touch pin for connecting the display and touch region to realize the touch function and a spare second touch pin;
touch wires, which are disposed between the display and touch chip and the display and touch region and connected to the display and touch region and the first touch pin; and
a grounding wire, which is disposed in the non-display touch region and connected to a ground phase of the display and touch region and the second touch pin;
the grounding wire comprises a grounding wire branch connected to the second touch pin and a main grounding wire connected to the ground phase of the display and touch region;
wherein the main grounding wire comprises a first wire section disposed below the display and touch chip and second wire sections which are connected to the first wire section and located on outer sides of the touch wires, the second wire sections are connected to the ground phase of the display and touch region, the width of the grounding wire branch is less than the width of the main grounding wire, and the grounding wire branch is connected to the second touch pin by a conducting adhesive.

2. The touch control panel according to claim 1, wherein there are two second wire sections which are disposed on two sides of all the touch wires to be connected to the first wire section to form a structure surrounding all the touch wires.

3. The touch control panel according to claim 2, wherein there are at least two groups of touch wires; the main grounding wire further comprises a third wire section disposed between two adjacent groups of touch wires; and, the third wire section is extended along an edge between the two groups of touch wires to form a sinuous wire section connected to the first wire section.

4. The touch control panel according to claim 2, wherein the grounding wire branch is connected to the first wire section.

5. The touch control panel according to claim 3, wherein the grounding wire branch is connected to the first wire section.

6. A touch control panel which is divided into a display and touch region and a non-display touch region disposed on one side of the display and touch region, wherein the touch control panel comprises:
a display and touch chip, which is disposed in the non-display touch region and configured to realize display and touch functions of the panel, and which comprises a first touch pin for connecting the display and touch region to realize the touch function and a spare second touch pin;
touch wires, which are disposed between the display and touch chip and the display and touch region and connected to the display and touch region and the first touch pin; and
a grounding wire, which is disposed in the non-display touch region and connected to a ground phase of the display and touch region and the second touch pin.

7. The touch control panel according to claim 6, wherein the grounding wire comprises a grounding wire branch connected to the second touch pin and a main grounding wire connected to the ground phase of the display and touch region;
wherein the main grounding wire comprises a first wire section disposed below the display and touch chip and second wire sections which are connected to the first wire section and located on outer sides of the touch wires, the second wire sections are connected to the ground phase of the display and touch region.

8. The touch control panel according to claim 7, wherein there are two second wire sections which are disposed on two sides of all the touch wires to be connected to the first wire section to form a structure surrounding all the touch wires.

9. The touch control panel according to claim 8, wherein there are at least two groups of touch wires; the main grounding wire further comprises a third wire section disposed between two adjacent groups of touch wires; and, the third wire section is extended along an edge between the two groups of touch wires to form a sinuous wire section connected to the first wire section.

10. The touch control panel according to claim 8, wherein the grounding wire branch is connected to the first wire section.

11. The touch control panel according to claim 9, wherein the grounding wire branch is connected to the first wire section.

12. The touch control panel according to claim 7, wherein the width of the grounding wire branch is less than the width of the main grounding wire.

13. The touch control panel according to claim 7, wherein the grounding wire branch is connected to the second touch pin by a conducting adhesive.

14. A display and touch control device, comprising a touch control panel and an iron back plate disposed in a back of the touch control panel, the touch control panel being divided into a display and touch region and a non-display touch region disposed on one side of the display and touch region, wherein the touch control panel comprises:
a display and touch chip, which is disposed in the non-display touch region and configured to realize display and touch functions of the panel, and which comprises a first touch pin for connecting the display and touch region to realize the touch function and a spare second touch pin;
touch wires, which are disposed between the display and touch chip and the display and touch region and connected to the display and touch region and the first touch pin; and
a grounding wire disposed in the non-display touch region, the grounding wire being connected to a ground phase of the display and touch region or the grounded iron back plate.

15. The display and touch control device according to claim 14, wherein, when the grounding wire is connected to the ground phase of the display and touch region, the grounding wire comprises a grounding wire branch connected to the second touch pin and a main grounding wire connected to the ground phase of the display and touch region;
the main grounding wire comprises a first wire section disposed below the display and touch chip and second wire sections which are connected to the first wire section and located outside the touch wires; and
there are two second wire sections which are disposed on two sides of all the touch wires so that the main grounding wire surrounds all the touch wires, and the second wire sections are connected to the ground phase of the display and touch region.

16. The display and touch control device according to claim 15, wherein there are at least two groups of touch wires; the main grounding wire further comprises a third wire section disposed between two adjacent groups of touch wires; and, the third wire section is extended along an edge between the two groups of touch wires to form a sinuous wire section connected to the first wire section.

17. The display and touch control device according to claim 16, wherein the grounding wire branch is connected to the first wire section.

18. The display and touch control device according to claim 15, wherein the width of the grounding wire branch is less than the width of the main grounding wire.

19. The display and touch control device according to claim 15, wherein the grounding wire branch is connected to the second touch pin by a conducting adhesive.

20. The display and touch control device according to claim 14, wherein, when the grounding wire is connected to the iron back plate, the grounding wire is connected to the iron back plate by an FPC (flexible printed circuit) board.
